(19) United States
(12) Patent Application Publication
(10) Pub. No.: US 2008/0300943 A1
(43) Pub. Date: Dec. 4, 2008

(54) TECHNIQUES FOR PROJECT TRANSFORMATION AND MANAGEMENT

(76) Inventors: Michel Shane Simpson, American Fork, UT (US); Volker Gunnar Scheuber-Heinz, Pleasant Grove, UT (US); Lee Edward Lowry, Orem, UT (US); William Street, Orem, UT (US)

Correspondence Address: SCHWEGMAN, LUNDBERG & WOESSNER/NOVELL, PO BOX 2938, MINNEAPOLIS, MN, 55402, US

(21) Appl. No.: 11/756,092

(22) Filed: May 31, 2007

(51) Int. Cl. G06Q 10/00

(52) U.S. Cl. 705/8

(57) ABSTRACT

Techniques for project transformation and management are provided. A project is defined via user-defined stages associated with its lifecycle. Each stage is associated with a set of resources and a particular processing environment. Each stage is dynamically and automatically configured and the resources of each stage are dynamically and automatically managed and transitioned to and from other stages. Policy drives the management and transitions of resources between the stages.

### FIELD

The invention relates generally to data processing and more particularly to techniques for project transformation and management.

### BACKGROUND

Increasingly enterprises and governments are turning to technology to automate and streamline their internal operations and business processes. Furthermore, the advent of the Internet and the World-Wide Web (WWW) has allowed enterprises and governments to delivery goods and services in an automated and nearly instantaneous fashion across the entire globe.

With any good or service provided by an enterprise or a government, there can be potentially a myriad of activities and expenses associated with those activities, which the enterprise or government endures before the good or service is available in the marketplace for consumption.

For example, word processing software has to be initially defined, developed and tested before it can be released for sale. These activities are usually managed internally by high-salaried project managers. For the most part, the project managers are administrators with skill in acquiring other personnel and equipment within an enterprise to make a project move from conception and development to release. In some cases, projects are so large within an enterprise that multiple layers of project managers are needed for any given project.

In large part, the industry has not been able to successfully automate and streamline the project management process. As a result, the cost of goods and services are likely unduly inflated and the time-to-market for goods and services is longer than it probably should be.

One reason for this lack of automation is the perceived complexity associated with project management in general. There are a variety of considerations such as laws, regulations, internal procedures that have to be followed. In addition, there may be limited personnel with specific skill sets some of which may be in high demand and unavailable within the enterprise and some of which the enterprise does not have and will have to contract out or hire in order to obtain.

Moreover, and perhaps the most insurmountable problem, is that there has to be an infrastructure of equipment and software systems to support product development for the project. In this case, an enterprise hires or maintains large support staffs to arrange, operate, and maintain the infrastructure. This staff may not even be related in any manner to the product being developed but this staff is indispensable to the success of the project. Additionally, the various software systems and computers used for the infrastructure have to be compatible and in many cases duplicated for different phases of the project (e.g., development versus quality assurance, etc.). This separation of environments within the infrastructure is crucial to the overall process and in some cases may be mandated. However, it also creates a lot of excess capacity and duplication between the phases in terms of equipment, software systems, and support staff.

Thus, what is needed is a mechanism, which allows for improved and automated project management.

### SUMMARY

In various embodiments, techniques for project transformation and management are provided. More specifically, and in an embodiment, a method is provided for project transformation and management. A schema definition is acquired for a plurality of stages associated with a lifecycle of a project. Relationships are established, in response to the schema definition, for each stage. The relationships selectively link resources in some stages to same or different resources of other stages. Additionally, the resources are automatically configured, in response to the schema definition, during each stage for processing environments associated with each stage. Furthermore, the project and the corresponding resources are dynamically transformed through and within the stages.

### BRIEF DESCRIPTION OF THE DRAWINGS

FIG. 1 is a diagram of a method for project transformation and management, according to an example embodiment.

FIG. 2 is a diagram of another method for project transformation and management, according to an example embodiment.

FIG. 3 is a diagram of an automated project lifecycle management system, according to an example embodiment.

FIG. 4 is a diagram of another automated project lifecycle management system, according to an example embodiment.

### DETAILED DESCRIPTION

A “resource” includes a user, content, a processing device, a node, a service, an application, a system, a schema definition, a directory, an operating system (OS), a file system, a data store, a database, a policy definition, a configuration definition, a file, a World-Wide Web (WWW) service, a WWW page, groups of users, combinations of these things, etc. The terms “service,” “application,” and “system” may be used interchangeably herein and refer to a type of software resource that includes instructions, which when executed by a machine performs operations that change the state of the machine and that may produce output.

In an embodiment, each resource is electronically defined and represented as having one or more attributes. Each attribute includes one or more name value pairs. For example, a server resource may include an attribute associated with its physical Internet Protocol (IP) address and that attribute may be represented by the following name value pair: “IP=100.1.1.10.” The server resource may also have its own identity (discussed below) and may include other attributes such as whether the IP address is static or dynamic, etc. Attributes may also include references to policy or even specific configuration details for a given processing environment that a resource is to be deployed to.

A “project” refers to the activity associated with an enterprise or government producing a good (product) or personal service (e.g., financial advice, etc.) for consumption in the marketplace. The activity for the project is defined in various stages of the project's lifecycle, such as by way of example only project definition, project development, project testing, project release, etc. Thus, a “project” is represented and electronically defined as a series of stages associated with the project's lifecycle. Each stage includes its own processing environment having its own or shared resources. So, a stage is represented and electronically defined as one or more resources and their relationships with other resources of the same stage or a different stage. A project may also be viewed as a type of resource.

A “processing environment” refers to one or more physical processing devices organized within a local network. For example, several computers connected via a local area network (LAN) may collectively be viewed as a processing environment. The processing environment also refers to software configurations of the physical processing devices, such as but not limited to operating system, file system, directory service, etc. A single processing environment may be logically defined, such that it spans multiple different networks (e.g., multiple different LAN's, a LAN and a wide-area network (WAN), etc.).

An “identity service” refers to a special type of service that is designed to manage and supply authentication services and authentication information for resources. So, an identity service may authenticate a given resource for access to a variety of local and external services being managed by that identity service. A single resource may have multiple identity services. In addition the identity service itself may be viewed as a type of resource. In this manner, identity service may authenticate and establish trust with one another viewing one another as specific type of resource.

According to an embodiment, some example identity services are described in “Techniques for Dynamically Establishing and Managing Authentication and Trust Relationships,” filed on Jan. 27, 2004, and having the U.S. Ser. No. 10/765,523; “Techniques for Establishing and Managing a Distributed Credential Store,” filed on Jan. 29, 2004, and having the U.S. Ser. No. 10/767,884; and “Techniques for Establishing and Managing Trust Relationships,” filed on Feb. 3, 2004, and having the U.S. Ser. No. 10/770,677; all of which are commonly assigned to Novell, Inc., of Provo, Utah and the disclosures of which are incorporated by reference herein.

An identity service may also provide single sign-on services to a resource. That is, a resource may sign-on to an identity service and acquire identities and credentials to access a variety of other services or resources. In some cases, the identity service is modified or enhanced to perform some of the teachings presented herein and below.

A resource is recognized via an “identity.” An identity is authenticated via various techniques (e.g., challenge and response interaction, cookies, assertions, etc.) that use various identifying information (e.g., identifiers with passwords, biometric data, hardware specific data, digital certificates, digital signatures, etc.). A “true identity” is one that is unique to a resource across any context that the resource may engage in over a network (e.g., Internet, Intranet, etc.). However, each resource may have and manage a variety of identities, where each of these identities may only be unique within a given context (given service interaction, given processing environment, given virtual processing environment, etc.).

The identity may also be a special type of identity that the resource assumes for a given context. For example, the identity may be a “crafted identity” or a “semantic identity.” An example for creating and using crafted identities may be found in U.S. patent application Ser. No. 11/225,993; entitled “Crafted Identities;” filed on Sep. 14, 2005; and the disclosure of which is incorporated by reference herein. An example for creating and using semantic identities may be found in U.S. patent application Ser. No. 11/261,970; entitled “Semantic Identities;” filed on Oct. 28, 2005; and the disclosure of which is incorporated by reference herein.

Various embodiments of this invention can be implemented in existing network architectures, security systems, data centers, and/or communication devices. Any particular architectural layout or implementation presented herein is provided for purposes of illustration and comprehension only and is not intended to limit aspects or embodiments of the invention.

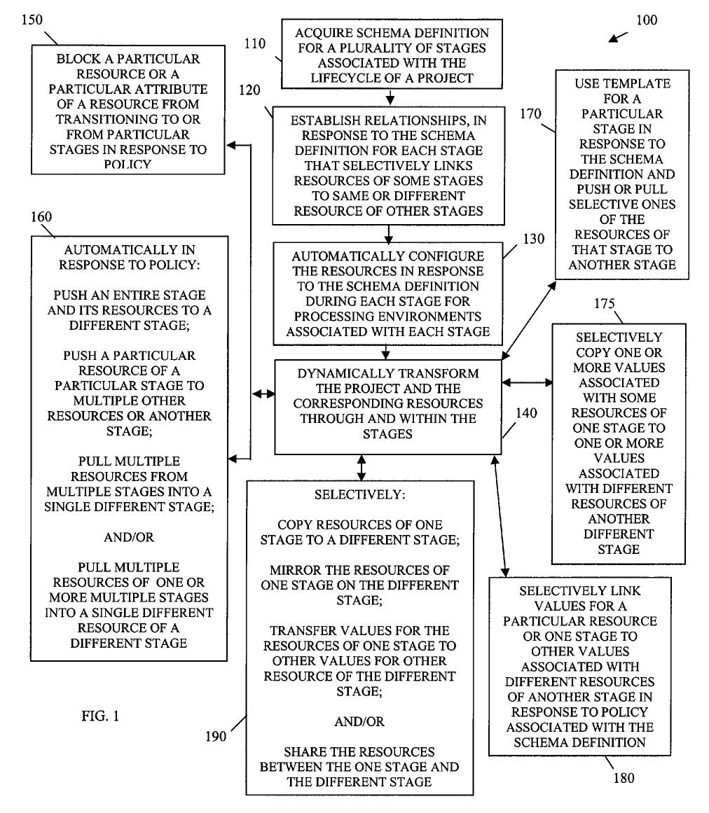

It is within this context, that various embodiments of the invention are now presented with reference to the FIGS. 1-4.

FIG. 1 is a diagram of a method 100 for project transformation and management, according to an example embodiment. The method 100 (hereinafter “project lifecycle management service”) is implemented as instructions in a machine-accessible and readable medium. The instructions when executed by a machine perform the processing depicted in FIG. 1. The project lifecycle management service is also operational over and processes within a network. The network may be wired, wireless, or a combination of wired and wireless.

As will be more fully described herein and below, the project lifecycle management service permits a project to be defined and managed in a consistent and automated manner across multiple independent stages associated with the lifecycle of the project. Each stage includes its own set of resources and processing environment. The resources are dynamically configured, transitioned, and managed within each stage and between the various stages of the lifecycle.

At 110, the project lifecycle management service acquires a schema definition for a plurality of stages associated with a lifecycle of a project. The schema definition identifies each of the stages for the project. Each portion of the schema definition that defines a particular stage includes definitions for a plurality of resources that are unique to that particular stage. Moreover, as discussed above, each resource includes a plurality of attributes and each attribute can include one or more name and value pairs.

In addition at 120, the project lifecycle management service establishes relationships or mappings, in response to the schema definition, for each stage. Each relationship or mapping, which is also defined in the schema, selectively links or logically associates resources associated with some stages to same or different resources of another stage. Again, the stages collectively define the project lifecycle and the schema definition includes stage definitions for each of the lifecycle stages. Each stage defining resources and attributes for those resources. In this manner, the entire project lifecycle and relationships or linkages between resources of the stages in the lifecycle are defined in a consistent and automated manner using the schema definition.

In an embodiment, the schema definition is in an extensible markup language (XML) format. This permits the schema definition to potentially be dynamically interpreted to process the schema definition, such as when the XML is accompanied by an XML schema definition (XSD). It is understood that any proprietary or commercially available data markup language may be used to represent the schema definition.

The relationships or links can be used to consistently define in an automated fashion associations between resources of different stages. For example, a server resource may connect to the Internet via a defined port in one stage and yet in another stage the same server resource may be used but connect to the Internet or another internal or external network via an entirely different port. In other cases, the server resource of one stage may be an entirely different resource associated with a different device in another stage. Essentially, resources may be linked, mapped, and associated with different or even same resources in completely different stages.

At 130, the project lifecycle management service automatically configures the resources in response to the schema definition during each stage for the processing environments associated with each stage. In other words, attributes of resources or even special resources associated with configuration information include settings and other configuration details for resources of a given stage to be configured to process and be accessible from a given processing environment associated with the given stage. This information permits automated configuration of each stage for its processing environment when policy dictates that a particular stage is to be instantiated and made active.

At 140, the project lifecycle management service dynamically transforms the project and the corresponding resources through and within the stages. Thus, policy acquired or associated with the schema definition drives processing to determine when transitions between resources or values or resources are to be transformed or communicated across and between stages of the project.

For example, suppose a project development stage for software includes a resource associated with development code that requires approval by a development review team to move the code to a testing stage. In this case the resource may be viewed as a development checklist. The checklist initially includes one attribute within a name and value pair assignment of: “CODE_ACCEPTED=NO.” After the code is reviewed and approved by the development review team, a notation is made to trigger a change within the development stage in the attribute name value pair to become such that it becomes: “CODE_ACCEPTED=YES.” When this occurs a relationship or link between the checklist resource of the development stage may drive processing according to policy to automatically lock down the code in a code library resource of the development stage and move it or schedule to move it to another resource (testing code library) in the testing stage and also make notations in a testing checklist resource. This may further schedule other resources and notify engineers to begin the testing processing on the code within the testing code library of the testing stage. It is to be understood that this illustration is presented to demonstrate but one scenario that many other more complex scenarios are achievable with the teachings presented herein and below.

In an embodiment, at 150, the project lifecycle management service may also use policy (derivable or associated with the schema definition) to block one or more particular resources or attributes of resources from ever transitioning to or from particular stages. For example, an IP address associated with a machine in development may be blocked from ever being viewed or transitioned to a production stage.

In addition, at 160, the project lifecycle management service may perform a variety of automatic and dynamic actions in response to policy. For example, the project lifecycle management service may use policy to automatically push an entire stage and its resources to a different stage as a collective and logical unit. Also, the project lifecycle management service may use policy to push a particular resource or a particular stage to multiple other resources of another stage. This one-to-many mapping or relationship may be referred to as “fan out.”Similarly, the project lifecycle management service may pull multiple resources from multiple stages into a single different resource of a different stage. This many-to-one mapping or relationship may be referred to as “fan in.” In still another example, the project lifecycle management service may pull multiple resources from multiple stages into a single different stage as a collective unit.

According to an embodiment, at 170, the project lifecycle management service may identify and use, in response to the schema definition or policy derived from the schema definition, a template. The template can be used to define push and pull situations for resources transitioning to and from stages.

In yet another case, at 175, the project lifecycle management service selectively copies one or more values associated with some attributes of resources for one stage to one or more values associated with the same or different attributes of resources for another different stage.

In still another situation, at 180, the project lifecycle management service selectively links values for a particular resource of one stage to other values associated with different resources of another stage. Again, this can be achieved in response to policy that is associated with the schema definition.

Finally, at 190, the project lifecycle management service may also selectively perform a variety of other beneficial and automated actions, such as copying resources of one stage to a different stage, mirroring the resources of one stage on or to an entirely different stage, transferring values for the resource of one stage to other values for other resources of a different stage, and/or share the resources between one stage and a different stage.

It is now appreciated how a project lifecycle can be logically and electronically defined via schema definitions having policy and/or templates in order to permit other automated services to entirely automate the project lifecycle in a dynamic, real time, consistent, reliable, and repeatable manner.

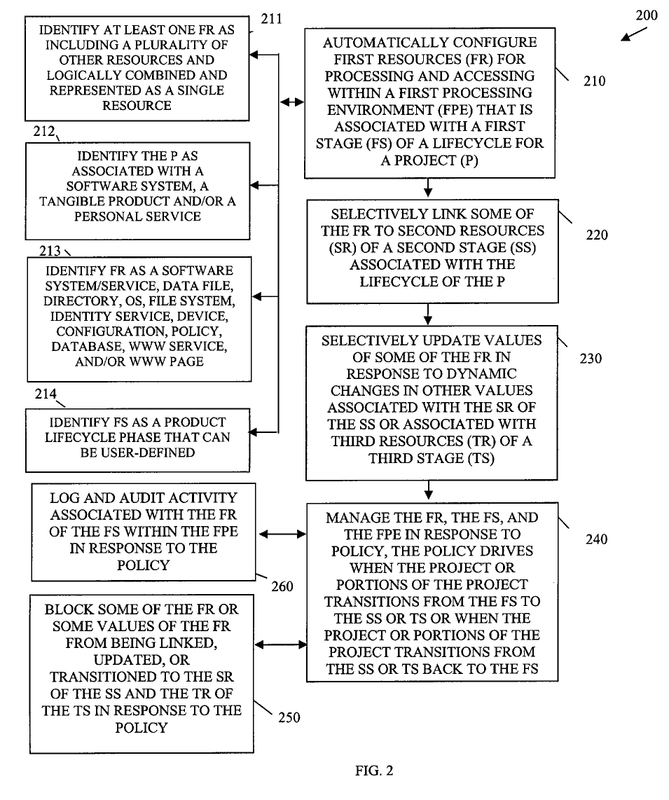

FIG. 2 is a diagram of another method for project transformation and management, according to an example embodiment. The method 100 (hereinafter “stage management service”) is implemented as instructions in a machine-accessible and readable medium. The instructions when executed by a machine perform the processing depicted in FIG. 2. The stage management service is also operational over and processes within a network. The network may be wired, wireless, or a combination of wired and wireless.

The stage management service represents processing associated with managing and transition a particular stage of a project's lifecycle. Conversely, the project lifecycle management service represented by the method 100 of the FIG. 1 presented a global perspective of project management across multiple stages of the project's lifecycle.

At 210, the stage management service automatically configures first resources for to be processed and to be accessed within a first processing environment. The first processing environment is associated with a first stage of a lifecycle of a project. The stage itself that that is being automatically configured can be any stage in the lifecycle. Thus, it may be the first stage, such as product definition, or it may be the last stage such as product release. The descriptions presented herein for the stage management service can work for any stage. Moreover, it is noted that the stages themselves may be user-defined.

According to an embodiment, at 211, the stage management service may identify at least one first resource as including one or more other resources. Thus, a resource definition can be nested to include multiple other resources. Moreover, the resources may be organized in user-defined hierarchies. Thus, multiple resources may be collectively handled and represented as a single collective and logical resource.

In another circumstance, at 212, the stage management service may identify the project itself as being associated with a software system, a tangible product being produced by an enterprise, and/or a personnel service that is being offered by an enterprise. In fact, a project may include various combinations of these things as well.

In still another embodiment, at 213, the stage management service identifies the first resources as being associated with a software service, a software system, a data file, a directory, and operating system (OS), a device, a configuration file, a policy definition, a database, a WWW service, a WWW page, etc.

In yet another case, at 214, the stage management service identifies the first stage as being associated with a product lifecycle that can include product definition phase for the lifecycle of the project, a product requirements phase for the lifecycle of the product, a development phase, a testing phase, a quality assurance phase, a pre-release phase, release phase, a production phase, and/or any other user-defined phase.

At 220, the stage management service selectively links some of the first resources to second resources of a second stage, which is also associated with the lifecycle of the project. Here, associations or mappings between resources that span multiple stages are recognized and managed. Examples of this were described in detail above with reference to the method 100 of the FIG. 1.

At 230, the stage management service selectively updates values of some of the first resources in response to dynamic changes in other values associated with the second resources of the second stage or even associated with third resources of a third stage. In fact, there is no limit on the number of different stages that the may be updated. The number of stages is bounded by the project definition (schema definition for the entire project and each of the stages).

At 140, the stage management service dynamically and in real time manages the first resources, the first stage, and the first processing environment in response to policy. The policy drives when the project or portions of the project transitions from the first stage to the second stage or even third stage. Additionally, the policy drives when the project or portions of the project transitions from the second stage or third stage back to the first stage. In other words, the management and transitions can occur with stages that are downstream to the first stage or can occur back to the first stage from other upstream stages. Movement between stages can be automated and managed via the policy.

According to an embodiment, at 250, the stage management service blocks some of the first resources or some of the values associated with attributes of the first resources from being linked, updated, and/or transitioned to the second to third stages in response to the policy. So, policy can prohibit some relationships and mappings even if they were attempted in a schema definition.

In another embodiment, at 260, the stage management service can log and audit activity associated with the first resources of the first stage within the first processing environment in response to policy. So, reporting, auditing, and notifying other resources or personnel may be achieved in automated manners in response to policy directives.

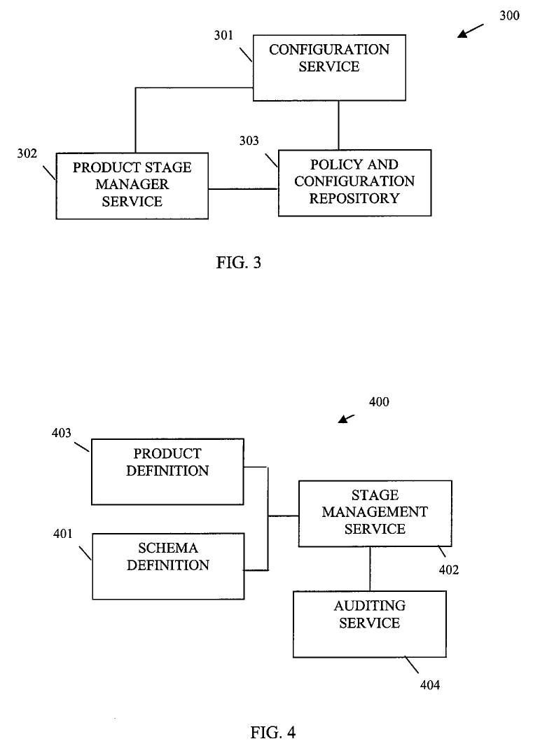

FIG. 3 is a diagram of an automated project lifecycle management system 300, according to an example embodiment. The automated project lifecycle management system 300 is implemented as instructions on or within a machine-accessible and readable medium. The instructions when executed by a machine perform various aspects of the processing depicted with respect to the methods 100 and 200 of the FIGS. 1 and 2, respectively. The automated project lifecycle management system 300 is also operational over a network and the network may be wired, wireless, or a combination of wired and wireless.

The automated project lifecycle management system 300 includes a configuration service 301 and a project stage manager service 302. In some cases, automated project lifecycle management system 300 may also include a policy and configuration repository 303. Each of these components and their interactions with one another will now be discussed in turn.

The configuration service 301 is implemented in a machine-accessible and readable medium and is to process on a machine. The configuration service 301 is processed to configure resources for purposes of being processed and being accessed from a processing environment, which is associated with a user-defined stage. The configuration service 301 is also to represent each of the resources as having one or more attributes. Each attribute includes a name and value pair assignment that is accessible to the project stage manager service 302. In an embodiment, at least one name of a particular attribute for a particular resource identifies another resource having its own name and value pairs. So, the name of an attribute for a resource can itself include a nested resource reference.

The configuration service 301 prepares a processing environment for a particular stage for processing and being accessed by the project stage manager service 302. This is achieved in a dynamic and automated fashion using policy and schema definitions for the stage.

The project stage manager service 302 is implemented in a machine-accessible and readable medium and is also to process on the machine or a different machine that is not the machine that processes the configuration service 301. The project stage manager service 302 is processed to use and evaluate policy for purposes of transitioning selective ones of the resources from the user-defined stage to another user-defined stage. Additionally, the project stage manager service 302 evaluates and uses the policy to receive other resources or attributes associated with those other resources from the different stage into the user-defined stage.

The project stage manager service 302 is to further interact, communicate, and cooperate with a different project stage manager service 302 associated with a different stage to manage the lifecycle for the project between the user-defined stage and the different user-defined stage. Example processing associated with the project stage manager service 302 was described in detail above with reference to the methods 100 and 200 of the FIGS. 1 and 2, respectively.

In some cases, the automated project lifecycle management system 300 also includes a policy and configuration repository (repository) 303. The repository 303 is implemented in a machine-accessible and readable medium and is accessible to the machine of the configuration service 301 or any different machine associated with the project stage manager service 302.

The repository 303 includes a schema definition for the user-defined stage and the resources of the user-defined stage. The schema definition is acquired from the repository 303 by the configuration service 301 and used to drive the dynamic and real-time configuration and instantiation of the processing environment associated with the user-defined stage.

Additionally, the repository 303 includes the policy that the project stage manager service 302 acquires and evaluates for purposes of managing and transitioning the resources from the user-defined stage to other different user-defined stages and receiving other resources and other values for those other resources into the user-defined stage from the different user-defined stage.

The policy is used to instruct and drive the processing of the project stage manager service 302. The actions that the policy may drive include, but are not limited to: mapping values or other attributes associated with the resources to other resources of a different user-defined stage; mirroring each of the resources or selective groupings of the resources from the user-defined stage to one or more different user-defined stages; copying selective ones of the resources from the user-defined stage to one or more different user-defined stages; blocking selective ones of the resources or selective values or attributes of those resources from transitioning from the user-defined stage to other different user-defined stages; mapping multiple ones of other resources associated with one or more different user-defined stages to a particular one of the resources included in the user-defined stage; replacing one or more of the resources included in the user-defined stage with selective ones of other resources associated with one or more different user-defined stages; and/or mapping multiple ones of the resources included in the user-defined stage to a single one of other resources associate with a different user-defined stage.

FIG. 4 is a diagram of another automated project lifecycle management system 400, according to an example embodiment. The automated project lifecycle management system 400 is implemented as instructions on or within a machine-accessible and readable medium. The instructions when executed by a machine perform various aspects of the processing depicted with respect to the methods 100 and 200 of the FIGS. 1 and 2, respectively, and processing associated with the system 100 of the FIG. 3. The automated project lifecycle management system 400 is also operational over a network and the network may be wired, wireless, or a combination of wired and wireless.

The automated project lifecycle management system 400 presents an alternative architecture and arrangement of components from that which was presented with the automated project lifecycle management system 300 of the FIG. 3.

The automated project lifecycle management system 400 includes a schema definition 401 and a stage management service 402. In some cases, automated project lifecycle management system 400 may also include a project definition 403 and an auditing service 404. Each of these components and their interactions with one another will now be discussed in turn.

The schema definition 401 is implemented in a machine-accessible and readable medium and is accessible to one or more machines. The schema definition 401 identifies the resources of the stage and identifies attributes for each of the resources. Each attribute includes one or more name and value pairs. The schema definition 401 also identifies within the attributes configuration information and mapping or linking information between resources of one stage and their associated with another stage. Additionally, each attribute or the schema definition 401 as a whole may be associated with one or more policies that are used to evaluate and determine when resource inter-stage transitioning or attribute value inter-stage transitioning is appropriate. Example usage of the schema definition 401 was presented in detail above with reference to the method 100 of the FIG. 1.

The stage management service 402 is implemented in a machine-accessible and readable medium and is to process on the one or more machines. The stage management service 402 acquires the schema definition 402 for configure a processing environment for a given stage for purposes of processing the resources of that stage and/or making those resources accessible within the processing environment.

Additionally, the stage management service 402 uses policies acquired or associated with the schema definition 401 to manage transitions of the resources from the stage configured to other stages of the lifecycle of a project. The stage management service 402 also manages mappings between other resources associated with other stages into the configured stage and its resources.

The policy may drive the stage management service 402 to perform a variety of beneficial, dynamic, and automatic actions or operations, such as but not limited to: selectively pushing some resources of the stage or each resource of the stage to other stages and/or pulling some other resources associated with other stages back into the stage. Example processing associated with the stage management service 402 was described in detail above with reference to the methods 100 and 200 of the FIGS. 1 and 2, respectively and with respect to the system 300 of the FIG. 3.

In an embodiment, the automated project lifecycle management system 400 also includes a project definition 403. The project definition 403 is implemented in a machine-accessible and readable medium and is accessible to the one or more machines.

The project definition 403 defines the stage that is configured, instantiated, and managed by stage management service 402. This may be done by incorporating or referencing the schema definition 401 within the project definition 403. Additionally, the project definition 403 defines each of the other stages associated with the lifecycle of the project by incorporating or referencing schema definitions 401 associated with each of those other stages within the project definition 403. So, the project definition 403 may be viewed as a Meta or global version of a schema definition 401 that incorporates each of the individual schema definitions 401 for each of the stages of the project's lifecycle.

Furthermore, each stage of the lifecycle may include its own independent schema definitions 401 and versions of the stage management service 402. Therefore, each stage achieves automated management via its schema definition 401 and via its stage management service 402 that cooperates and interacts with over versions of the stage management service 402 associated with the other stages of the lifecycle.

According to an embodiment, the automated project lifecycle management system 400 also includes an auditing service 404. The auditing service 404 is implemented in a machine-accessible and readable medium and is to process on the one or more machines.

The auditing service 404 interacts with or monitors the stage management service 402 for purposes of recording and reporting actions taken within the stage by the resources and the stage management service 402.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. § 1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A method, comprising:
acquiring a schema definition for a plurality of stages associated with a lifecycle of a project;
establishing relationships, in response to the schema definition, for each stage that selectively links resources in some stages to same or different resources of other stages;
automatically configuring the resources, in response to the schema definition, during each stage for processing environments associated with each stage; and
dynamically transforming the project and the corresponding resources through and within the stages.

2. The method of claim 1 further comprising, blocking a particular resource or a particular attribute of a resource from transitioning to or from particular stages in response to policy associated with the schema definition.

3. The method of claim 1 further comprising one or more of the following:
automatically pushing an entire stage and its resources to another different stage as a collective unit in response to policy associated with the schema definition;
automatically pushing a particular resource of a particular stage to multiple other resources of another stage in response to the policy associated with the schema definition;
automatically pulling multiple resources from multiple stages into a single different stage in response to the policy associated with the schema definition; and
automatically pulling multiple resources of one or multiple stages into a single different resource of a different stage in response to the policy associated with the schema definition.

4. The method of claim 1 further comprising, using a template for a particular stage that is associated with or acquired in response to the schema definition to automatically push or pull selective ones of the resources of that stage to another different stage.

5. The method of claim 1 further comprising, selectively copying one or more values associated with some resources of one stage to one or more values associated with different resources of another different stage.

6. The method of claim 1 further comprising one or more of the following:
selectively copying resources of one stage to another different stage;
selectively mirroring the resources of the one stage to the different stage;
selectively transferring values of the resources of the one stage to other values of other resources associated with the different stage; and
selectively sharing the resources between the one stage and the different stage.

7. The method of claim 1 further comprising, selectively linking values for particular resources of one stage to other values associated with different resources of another stage in response to policy associated with the schema definition.

8. A method, comprising:
automatically configuring first resources for processing and accessing within a first processing environment that is associated with a first stage of a lifecycle for a project;
selectively linking some of the first resources to second resources of a second stage associated with the lifecycle of the project;
selectively updating values of some of the first resources in response to dynamic changes in other values associated with the second resources of the second stage or associated with third resources of a third stage; and
managing the first resources, the first stage, and the first processing environment in response to policy, wherein the policy drives when the project or portions of the project transitions from the first stage to the second or third stages or when the project or portions of the project transitions from the second or third stages back to the first stage.

9. The method of claim 8 further comprising, blocking some of the first resources or some values associated with some of the first resources from being linked, updated, or transitioned to the second resources of the second stage and the third responses of the third stage in response to the policy.

10. The method of claim 8, wherein automatically configuring further includes identifying at least one of the first resources as including a plurality of other resources that are logically combined and represented as a single first resource.

11. The method of claim 8, wherein automatically configuring further includes identifying the project being associated with one or more of the following: a software system, a tangible product, and a personal service offered by an enterprise.

12. The method of claim 8, wherein automatically configuring further includes identifying the first resources as one or more of the following: a software service, a software system, a data file, a directory, an operating system, a file system, an identity service, a device, a configuration file, a particular policy, a database, a World-Wide Web (WWW) service, and WWW page.

13. The method of claim 8, wherein automatically configuring further includes identifying the first stage as one of the following: a project definition phase for the lifecycle of the project, a project requirements phase for the lifecycle of the project, a development phase for the lifecycle of the project, a testing phase for the lifecycle of the project, a quality assurance phase for the lifecycle of the project, a pre-release phase for the lifecycle of the project, a release phase for the lifecycle of the project, a production phase for the lifecycle of the project, and a user-defined phase for the lifecycle phase of the project.

14. The method of claim 8, further comprising, logging and auditing activity associated with the first resources of the first stage within the first processing environment in response to the policy.

15. A system, comprising:
a configuration service implemented in a machine-accessible and readable medium and to process on a machine; and
a project stage manager service implemented in a machine-accessible and readable medium and to process on the machine or a different machine, wherein the configuration service is to configure resources to process and to be accessible from a processing environment associated with a user-defined stage of a lifecycle of a project, and wherein the project stage manager service is to use policy to transition selective ones of the resources from the user-defined stage to another different user-defined stage and is to use the policy to receive other resources or attributes associated with the resources from the different stage into the user-defined stage.

16. The system of claim 15 further comprising, a policy and configuration repository implemented in a machine-accessible and readable medium and accessible to the machine or the different machine, wherein the policy and configuration repository includes a schema definition for the user-defined stage and the resources, the schema definition is to be acquired by the configuration service to configure the resources, and wherein the policy and configuration repository includes the policy that is to be acquired and evaluated by the project stage manager service for the user-defined stage of the lifecycle of the project.

17. The system of claim 16, wherein policy is to instruct the project stage and manager service to perform one or more of the following actions: map values or other attributes associated with the resources to the other resources of the different user-defined stage, mirror each of the resources or selective ones of the resources to the different user-defined stage, copy selective ones of the resources to the different user-defined stage, block selective ones of the resources or selective ones of the values or the attributes from transitioning to the different user-defined stage, map multiple ones of the other resources associated with the different user-defined stage to a particular one of the resources of the user-defined stage, replace one or more of the resources of the user-defined stage with selective ones of the other resources associated with the different user-defined stage, and map multiple ones of the resources to a single one of the other resources associated with the different user-defined stage.

18. The system of claim 15, wherein the configuration service is to represent each of the resources as having one or more attributes and each attribute including a name and value pair assignment accessible to the project stage and manager service during evaluation of the policy.

19. The system of claim 18, wherein at least one name of a particular attribute for a particular resource identifies another resource having its own name and value pairs.

20. The system of claim 15, wherein the project stage and manager service is to interact and communicate with a different project stage and manager service associated with the different stage to manage the lifecycle of the project between the user-defined stage and the different user-defined stage.

21. A system, comprising:
a schema definition for a stage of a lifecycle associated with a project, wherein the schema definition is implemented in a machine-accessible and readable medium and is accessible to one or more machines; and
a stage management service implemented in a machine-accessible and readable medium and to process on the one or more machines, wherein the stage management service is to use the schema definition to configure resources of a stage associated with the lifecycle for a processing environment and the stage management service is to use policy associated with the schema definition and the stage to manage transitions of the resources to other stages of the lifecycle and is to manage mappings between other resources of the other stages to the stage and its resources.

22. The system of claim 21 further comprising, a project definition implemented in a machine-accessible and readable medium and is accessible to the one or more machines, wherein the project definition defines the stage by incorporating or including the schema definition and defines the other stages by incorporate or including other schema definitions associated with the other stages.

23. The system of claim 21, wherein the schema definition identifies the resources of the stage and identifies attributes for each of the resources, each attribute includes one or more name and value pair assignments.

24. The system of claim 21, wherein the other stages include their own schema definitions for their stages of the lifecycle of the project and also include their own stage management services.

25. The system of claim 21, wherein the stage management service is to transition the resources by automatically, dynamically and selectively pushing some resources or each of the resources to the other stages or by automatically, dynamically, and selectively pulling some of the other resources from the other stages to the stage.

26. The system of claim 21 further includes, an auditing service implemented in a machine-accessible and readable medium and to process on the one or more machines, wherein the auditing service is to record and to report actions taken within the stage by the resources and the stage management service.
